(19) United States
(12) Patent Application Publication
(10) Pub. No.: US 2008/0090037 A1
(43) Pub. Date: Apr. 17, 2008

(54) Laminate For Packaging And Packaging Bag And Bag For Packaging Electronic Material Product Each Comprising The Same

(75) Inventor: Toru Masuda, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Showa Denko Packaging Co., Kanagawa (JP)

(21) Appl. No.: 11/719,031

(22) PCT Filed: Nov. 9, 2005
(86) PCT No.: PCT/JP05/20507

§ 371 Date: May 10, 2007

(30) Foreign Application Priority Data
Nov. 10, 2004 (JP) 2004-326083

(51) Int. Cl. B32B 1/08; C08F 210/00

(52) U.S. Cl. 428/35.2; 526/348

(57) ABSTRACT

A packaging laminate of the present invention is characterized in that it has at least a sealant layer (2), the sealant layer (2) being a film which comprises a linear ethylene/α-olefin copolymer, has a density of 0.925-0.935 g/cm³, and contains no additives, and that the linear ethylene/α-olefin copolymer is either a copolymer produced with a metallocene catalyst as a polymerization catalyst or a copolymer which has been obtained by subjecting a linear ethylene/α-olefin copolymer produced with a Ziegler catalyst as a polymerization catalyst to an operation for removing ionic impurities and in which contained ionic impurities have been reduced or removed. The packaging laminate has a significantly reduced content of ionic impurities such as metal ions and has a significant seal strength and excellent slip properties.

### TECHNICAL FIELD

The present invention relates to a packaging laminate and a packaging bag for preferably use in packaging an electronic material product, such as, e.g., a wafer case in which a silicon wafer, a compound semiconductor wafer, a hard disk, etc. is enclosed.

### BACKGROUND ART

Electronic materials, such as, e.g., silicon wafers, compound semiconductor wafers (e.g., gallium-phosphorus wafers), or hard disks, are extremely high in clean degree demand. For example, a disk-shaped product, such as, e.g., a silicon wafer, a compound semiconductor wafer or a hard disk, is generally packaged with a clean packaging bag made of a laminate having a sealant layer of polyethylene after being encased in a cleanly washed box-like resin case. In such a packaging bag packaging an electronic material product, in the case of the lack of the air-tightness of the inner resin case, the so-called respiration phenomenon in which air enters into and exits from the resin case due to the pressure changes of the ambient environment during the transport process occurs. For example, in cases where it is temporarily stored as an air cargo in a warehouse of a high temperature environment in an airport or in cases where it is stored as an air cargo in a cargo compartment of an aircraft and the pressure is reduced up in the sky, the respiration phenomenon occurs by the pressure changes. When such a respiration phenomenon occurs, ionic impurities existing especially in the innermost layer and/or suspended particles of the packaging bag adheres to the surface of the clean electronic material encased in the resin case, which contaminates the electronic material. Accordingly, it is strongly required that the sealant layer constituting the innermost layer of the packaging bag is less in content of ionic impurities and adhered amount of the suspended particles.

In order to meet such a demand, the present applicant proposed a packaging laminate in which a low density polyethylene film having a density of 0.92 g/cm³ or less and a melt flow rate of 0.3 to 5 g/10 min is used as the sealant layer, wherein the low density polyethylene film is produced by a high pressure radical polymerization method using one or a plurality of perioxide series radical initiators falling within the range of 150 to 200° C. in half-life (see Patent Document 1).

Patent Document 1: Japanese Unexamined Laid-open Patent Publication No. 2003-191363 (claim 4)

### DISCLOSURE OF THE INVENTION

### Problems to be Solved by the Invention

Although the aforementioned packaging laminate is extremely excellent in that the content of ionic impurities, such as, e.g., metallic ions, is small, there is a drawback that the seal strength is about 30 to 40 N/15 mm (in the case of 40 μm thickness) and therefore sufficient seal strength cannot be obtained. In recent years, overseas shipping of electronic material products is generally performed utilizing an air cargo. At about 10,000 m in the sky, it is said that a cargo compartment of an aircraft becomes about 0.2 in atmospheric pressure. This causes a phenomenon of an expansion of a packaging bag packaging an electronic material product. At this time, if the seal strength of the packaging bag is insufficient, the packaging bag will blow up. It is experientially said that the blow-up trouble of the packaging bag in the cargo compartment in the sky can be reduced if the seal strength of the packaging bag is about 48 N/15 mm or more.

On the other hand, as a packaging film, a linear low density polyethylene film produced with a Ziegler catalyst as a polymerization catalyst has been conventionally known. In cases where a packaging bag is produced using the film as a sealant layer, however, a high seal strength of about 50 to 65 N/15 mm can be obtained, and therefore it is considered to be preferable to package an electronic material product. However, metals and inorganic ions constituting the Ziegler catalyst remain within the film, and therefore there is a problem that the ionic impurity density is high. Furthermore, in the case of the carrier carrying type Ziegler catalyst, magnesium ions or the like constituting the carrier remain within the film, which further increases the ionic impurity density.

In a packaging film, in order to improve the slip property on the film surface, it is often to add, for example, erucicamide. In this case, there is a problem that ionic impurities containing nitrogen atoms (e.g., ammonia ion, nitrate ion, nitrite ion, etc.) increase.

A density of a common linear low density polyethylene film is about 0.923 g/cm³ or less. The present inventors' study revealed that in the case of using such a film as a sealant layer of a packaging bag, a sufficient slip property of the film surface cannot be obtained when an additive agent such as the aforementioned additive agent is not contained.

The present invention was made in view of the aforementioned technical background, and aims to provide a packaging laminate with an extremely reduced content of ionic impurities such as metallic ions which is sufficient in seal strength and excellent in slip property, and a packaging bag and a semiconductor product packaging bag using the packaging laminate.

### Means to Solve the Problems

In order to attain the aforementioned objects, the present invention provides the following means.

[1] A packaging laminate, comprising at least a sealant layer,

wherein the sealant layer comprises a film having a density of 0.925 to 0.935 g/cm³ and containing a linear ethylene/α-olefin copolymer, the film containing no additive, and

wherein the linear ethylene/α-olefin copolymer is a copolymer produced with a metallocene catalyst as a polymerization catalyst.

[2] A packaging laminate, comprising at least a sealant layer,

wherein the sealant layer comprises a film having a density of 0.925 to 0.935 g/cm³ and containing a linear ethylene/α-olefin copolymer, the film containing no additive,

wherein as the linear ethylene/α-olefin copolymer, a copolymer obtained by subjecting a linear ethylene/α-olefin copolymer produced with a Ziegler catalyst as a polymerization catalyst to an ionic impurity removing operation and in which contained ionic impurities have been diminished or removed is used.

[3] The packaging laminate as recited in the aforementioned Item [2], wherein the ionic impurity removing operation is an operation for reducing or removing contained ionic impurities such as a Zeigler catalyst utilizing a chelation reaction of a Ziegler catalyst and a chelate agent.

[4] The packaging laminate as recited in the aforementioned Item [2], wherein the ionic impurity removing operation is an operation for reducing or removing contained ionic impurities such as a Zeigler catalyst by performing an operation for cutting a molten copolymer in clean warm water at the time of palletizing the linear ethylene/α-olefin copolymer during a granulation process.

[5] The packaging laminate as recited in any one of Items [1] to [4], wherein the film constituting the sealant layer is 0.928 to 0.933 g/cm³ in density.

[6] A packaging bag using the packaging laminate as recited in any one of the aforementioned Item [1] to [5], wherein the sealant layer of the packaging laminate constitutes an innermost layer of the packaging bag.

[7] A packaging bag for electronic material products using the packaging laminate as recited in any one of the aforementioned Items [1] to [5], wherein the sealant layer of the packaging laminate constitutes an innermost layer of the packaging bag.

### EFFECTS OF THE INVENTION

In the invention of the aforementioned Item [1], since the sealant layer is made of a film containing a linear ethylene/α-olefin copolymer produced with a metallocene catalyst as a polymerization catalyst, heat sealing can be performed and sufficient seal strength can be obtained. Accordingly, for example, in a packaging bag produced using the laminate of this invention, the packaging bag would not be broken from the sealed portion even if the packaging bag expands when a cargo compartment of an aircraft became a midair low pressure state with an electronic material product packaged in a sealed manner. Furthermore, the linear ethylene/α-olefin copolymer constituting the sealant layer is a copolymer produced with a metallocene catalyst as a polymerization catalyst and the sealant layer contains no additive. Therefore, the content of ionic impurities, such as, e.g., metallic ions or inorganic ions, is extremely small, which prevents the ionic impurities from being transferred to a packaging object. For example, in a case in which a packaging bag is produced using the laminate of the present invention and an electronic material product is packaged therein, the transition of ionic impurities to the electronic material product can be prevented. Furthermore, since the density of the film containing the linear ethylene/α-olefin copolymer is set so as to fall within the range of 0.925 to 0.935 g/cm³, the laminate is excellent in slip property and can have appropriate flexibility, which in turn can sufficiently improve the packaging workability. In this invention [1], the content of ionic impurities in the sealant layer can be reduced without performing an ionic impurity removing operation. Therefore, the productivity is excellent and the cost can be reduced.

In the invention [2], the sealant layer is made of a film containing a linear ethylene/α-olefin copolymer produced with a Ziegler catalyst as a polymerization catalyst. Therefore, heat sealing can be performed and sufficient seal strength can be obtained. Accordingly, for example, in a packaging bag produced using the laminate of this invention, the bag would not be broken from the sealed portion even if the packaging bag expands when a cargo compartment of an aircraft became a midair low pressure state with an electronic material product packaged in a sealed manner. Furthermore, the linear ethylene/α-olefin copolymer constituting the sealant layer is a copolymer obtained by subjecting a linear ethylene/α-olefin copolymer produced with a Ziegler catalyst as a polymerization catalyst to an ionic impurity removing operation and in which contained ionic impurities have been reduced or removed and the sealant layer contains no additive. Therefore, the content of ionic impurities, such as, e.g., metallic ions or inorganic ions, is extremely small, which prevents the ionic impurities from being transferred to a packaging object. For example, in a case in which a packaging bag is produced using the laminate of the present invention and an electronic material product is packaged therein, the transition of ionic impurities to the electronic material product can be prevented. Furthermore, since the density of the film containing the linear ethylene/α-olefin copolymer is set so as to fall within the range of 0.925 to 0.935 g/cm³, the laminate is excellent in slip property and can have appropriate flexibility, which in turn can sufficiently improve the packaging workability.

In the invention [3], the ionic impurity removing operation is an operation for reducing or removing contained ionic impurities, such as, e.g., a Zeigler catalyst residual, utilizing a chelation reaction of a Ziegler catalyst and a chelate agent. Therefore, ionic impurities can be sufficiently removed.

In the invention [4], the ionic impurity removing operation is an operation for reducing or removing contained ionic impurities, such as, e.g., a Zeigler catalyst residual, by performing an operation for cutting a molten copolymer in clean warm water at the time of palletizing the linear ethylene/α-olefin copolymer during the granulation process thereof. Therefore, ionic impurities can be sufficiently removed.

In the invention [5], since the film constituting the sealant layer is 0.928 to 0.933 g/cm³ in density, the slip property can be further improved and an appropriate flexibility can be obtained. This further improves the packaging workability.

In the invention [6], sufficient seal strength can be obtained. Accordingly, for example, the bag would not be broken from the sealed portion even if the packaging bag expands when a cargo compartment of an aircraft became a midair low pressure state with an electronic material product packaged in a sealed manner. Furthermore, the sealant layer is very small in content of ionic impurities, such as, e.g., metallic ions or inorganic ions, which prevents the ionic impurities from being transferred to a packaging object. Furthermore, since the density of the film containing the linear ethylene/α-olefin copolymer constituting the sealant layer is set so as to fall within the range of 0.925 to 0.935 g/cm³, the laminate is excellent in slip property and can have appropriate flexibility, which in turn can sufficiently improve the packaging workability.

In the invention [7], sufficient seal strength can be obtained. Accordingly, the packaging bag would not be broken from the sealed portion even if the packaging bag expands when a cargo compartment of an aircraft became a midair low pressure state with an electronic material product packaged in a sealed manner. Furthermore, the sealant layer is very small in content of ionic impurities, such as, e.g., metallic ions or inorganic ions, which prevents the ionic impurities from being transferred to a packaging object. Furthermore, since the density of the film containing the linear ethylene/α-olefin copolymer constituting the sealant layer is set so as to fall within the range of 0.925 to 0.935 g/cm³, the laminate is excellent in slip property and can have appropriate flexibility, which in turn can sufficiently improve the packaging workability.

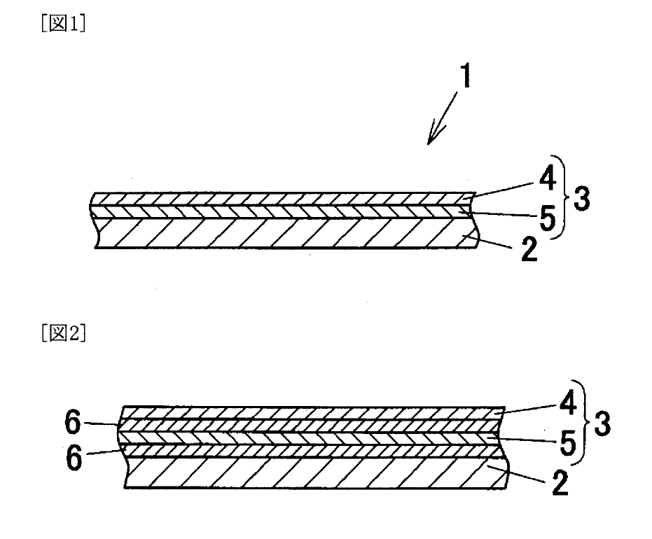

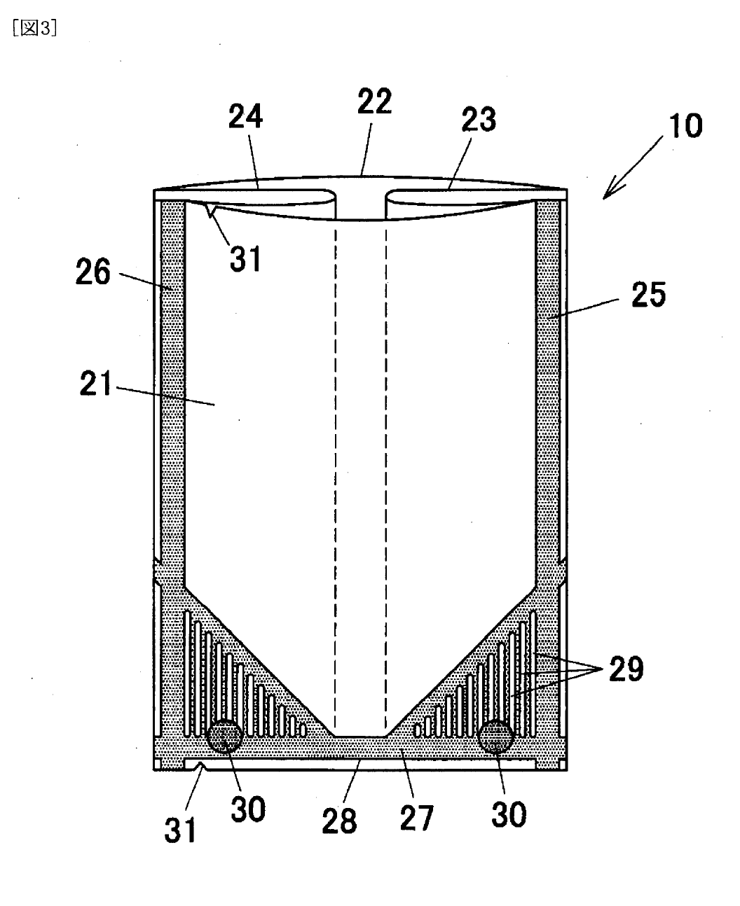

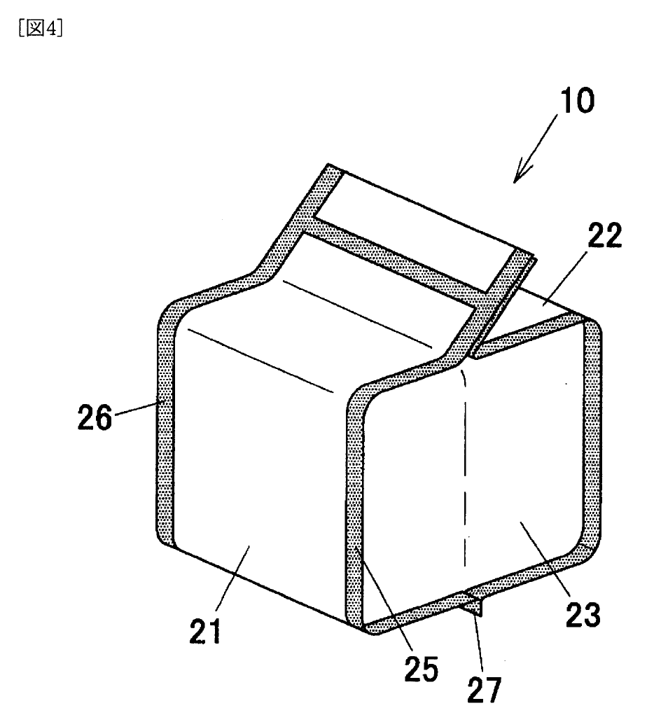

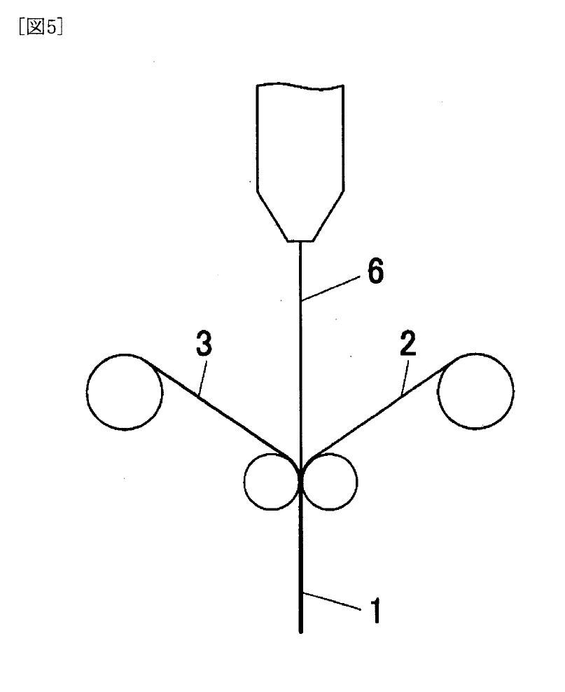

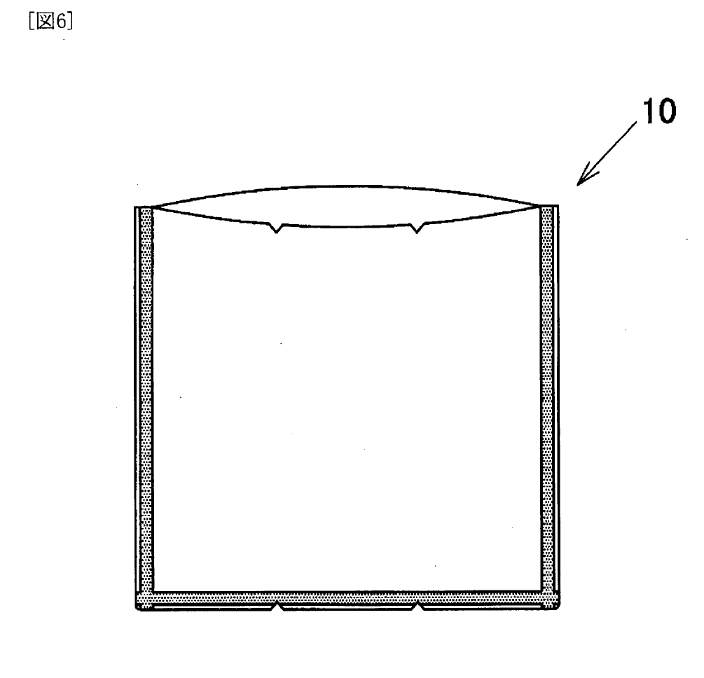

### BRIEF EXPLANATION OF DRAWINGS

[FIG. 1] is a cross-sectional view showing a packaging laminate according to an embodiment of this invention.

[FIG. 2] is a cross-sectional view showing another embodiment of a packaging laminate of this invention.

[FIG. 3] is a front view showing a packaging bag according to an embodiment of this invention in a closed state.

[FIG. 4] is a perspective view showing a usage state of a packaging bag according to an embodiment of this invention.

[FIG. 5] is a view showing an example of a production method of a packaging laminate according to this invention.

[FIG. 6] is a front view showing a packaging bag according to another embodiment of this invention in a closed state.

### DESCRIPTION OF REFERENCE NUMERALS

1 . . . Packaging laminate
2 . . . Sealant layer
3 . . . Base material layer
4 . . . Surface layer
5 . . . Intermediate layer
6 . . . Adhesive agent layer
10 . . . Packaging bag

### BEST MODE FOR CARRYING OUT THE INVENTION

An embodiment of a packaging laminate 1 according to the present invention is shown in FIG. 1. This packaging laminate 1 has a base material layer 3 and a sealant layer 2. In this embodiment, the base material layer 3 has a surface layer 4 and an intermediate layer 5. In this embodiment, the layers 2, 4 and 5 are bonded each other by a dry laminate method using an adhesive agent (not illustrated)

The sealant layer 2 is a film having a density of 0.925 to 0.923 g/cm³ and containing a linear ethylene/α-olefin copolymer, and the film contains no additive (e.g., lubricant, antiblocking agent, antistatic agent, antioxidizing agent, ultraviolet absorber). Furthermore, the linear ethylene/α-olefin copolymer is (a) a copolymer produced with a metallocene catalyst as a polymerization catalyst, or (b) a copolymer obtained by subjecting a linear ethylene/α-olefin copolymer produced with a Ziegler catalyst as a polymerization catalyst to an ionic impurity removing operation.

As mentioned above, in this invention, the sealant layer 2 is made of a film containing a linear ethylene/α-olefin copolymer produced with a Ziegler catalyst as a polymerization catalyst. Accordingly, for example, by producing the packaging bag 10 using the laminate 2 of this invention, the bag would not be broken from the sealed portion even if the packaging bag 10 expands when a cargo compartment of an aircraft became a midair low pressure state with an electronic material product packaged in a sealed manner.

Furthermore, since the sealant layer 2 is made of a film having a density of 0.925 to 0.935 g/cm³ and containing a linear ethylene/α-olefin copolymer, this sealant layer 2 is excellent in slip property and has an appropriate flexibility. Accordingly, it can sufficiently improve the packaging workability at the time of packaging a packaging object. If the density is less than 0.925 g/cm³, the slip property is not sufficient, which deteriorates the packaging workability. On the other hand, if the density exceeds 0.935 g/cm³, the laminate becomes excessively stiff, resulting in deteriorated packaging workability. In the case where the packaging bag is transparent, the transparency (visibility of the inside) deteriorates. In addition, the heat seal temperature becomes high. Among other things, the density of the film constituting the sealant layer 2 is preferably 0.928 to 0.933 g/cm³.

Furthermore, since the linear ethylene/α-olefin copolymer constituting the sealant layer 2 is a copolymer produced with a metallocene catalyst as a polymerization catalyst or a copolymer obtained by subjecting a linear ethylene/α-olefin copolymer produced with a Ziegler catalyst as a polymerization catalyst to an ionic impurity removing operation, the content of ionic impurities, such as, e.g., metallic ions or inorganic ions, is extremely small, which prevents the ionic impurities from being transferred to a packaging object (e.g., electronic material product). Furthermore, since the sealant layer 2 contains no additive, the content of ionic impurities can be sufficiently decreased. For example, by producing a packaging bag using the laminate 1 of the present invention and packaging an electronic material product therein, the transition of ionic impurities to the electronic material product can be prevented. The reason that the content of ionic impurities becomes very small when the bag is produced using a metallocene catalyst as a polymerization catalyst is as follows. The catalyst activity of the metallocene catalyst per transition metal dramatically improves as compared with a conventional solid series heterogeneous catalyst (multisite series), and a sufficient catalyst activity can be obtained by a small amount of catalyst. Therefore, the usage of the metallocene catalyst can be very small.

The metallocene catalyst is not specifically limited to a specific one. Biscyclopentadienyl complex salt (C₅H₅)₂M comprising two cyclopentadiene rings and various transition metals can be exemplified. As the transition metal M constituting the biscyclopentadienyl complex salt can be, for example, Zr, Ti, V, Cr, Mn, Co, Ni, Mo, Ru, Rh, Lu, Ta, W, Os, and Ir.

The Zeigler catalyst is a catalyst which is a combination of I, II, III group of the periodic system metallic organic compound and IV, V, VI, VII, VIII group of the periodic system metallic compound, but not specifically limited. For example, a catalyst made of Ti chloride and organic aluminum compound carried by a carrier can be exemplified.

The ionic impurity removing operation is not specifically limited. For example, a method of reducing or removing ionic impurities by a chemical method, and a method of reducing or removing ionic impurities by a physical method can be exemplified.

The method of reducing or removing by a chemical method is not specifically limited. For example, a method of reducing or removing contained ionic impurities such as a Zeigler catalyst residual utilizing a chelation reaction of a Ziegler catalyst and a chelate agent can be exemplified. The chelate agent is not specifically limited. For example, acetylacetone and propylene oxide can be exemplified.

The method of reducing or removing by a physical method is not specifically limited. For example, a method of reducing or removing contained ionic impurities such as a Ziegler catalyst residual by performing an operation for cutting a molten copolymer in clean warm water (e.g., 50 to 80° C. warm water) at the time of palletizing the linear ethylene/α-olefin copolymer during the granulation process thereof can be exemplified (the contained ionic impurities can be removed by being solved in the warm water). The cutting can be performed with, e.g., a high speed rotating blade.

The α-olefin of the linear ethylene/α-olefin copolymer is not specifically limited. For example, one or more of α-olefin selected from the group consisting of butane-1, pentene-1, 3-methylbutene-1, hexene-1, 4-methylpentene-1 and octene-1 can be used.

To the sealant layer 2, another resin other than the linear ethylene/α-olefin copolymer having the aforementioned characteristic can be mixed within the range which does not harm the effects of the invention. However, from the view point of sufficiently reducing the content of the ionic impurities in the sealant layer 2, it is preferable to employ the structure that the sealant layer 2 includes only the linear ethylene/α-olefin copolymer having the aforementioned characteristics.

The packaging laminate 1 of this invention is equipped with the sealant layer 2 having the aforementioned characteristics and the base material layer 3 laminated on the sealant layer 2. The base material layer 3 is equipped with at least surface layer 4. If needed, one or more intermediate layers 5 can be further provided. However, the structure is not specifically limited to these exemplified laminate structures.

The surface layer 4 is not specifically limited. For example, a layer made of a barrier property film having, e.g., a light blocking property, an oxygen gas barrier property, and/or a moisture barrier property can be exemplified. The surface layer 4 is preferably transparent from the view point of confirming the packaging object enclosed in the packaging bag 10 made of the laminate 1 of this invention. In cases where the packaging object is easily affected by light, a barrier property film having a light blocking property is used.

As the surface layer 4, in cases where the transparency and oxygen gas barrier property are required, for example, a biaxially drawn polyethylene terephthalate (PET) film on which oxidized silicon or metal oxide is deposited, a biaxially drawn polypropylene (PP) film, and a biaxially drawn polyamide film can be used. Furthermore, a biaxially drawn PET film on which polyvinylidene chloride or polyvinyl alcohol is coated, a biaxially drawn PP film, an ethylene-vinyl acetate copolymer saponified film, a polyvinyl alcohol film, or a polycarbonate film can be used.

Furthermore, as the surface layer 4, in cases where a light blocking property and an oxygen gas barrier property are required, for example, an aluminum foil, a biaxially drawn PET film, a biaxially drawn PP film on which an aluminum foil is adhered, a biaxially drawn PET film, or a biaxially drawn PP film on which metallic aluminum is deposited can be used.

The intermediate layer 5 is a layer for mainly compensating the mechanical strength (impaling strength) and various barrier properties of the laminate 1. As a film for the intermediate layer 5, for example, a drawn or non-drawn plastic film of, for example, polypropylene, polyethylene terephthalate, polyamide (e.g., nylon-6, nylon-6,6), cellulose acetate, ethylene-vinyl acetate copolymer saponity, polycarbonate, a paper or an aluminum foil can be exemplified.

As shown in FIG. 2, it is possible to employ the structure in which each of the layers 2, 4 and 5 are integrally laminated with adhesive agent layers 6 and 6. This adhesive agent layer 6 is formed by a molten extruded layer (PE extruded layer) of a thermoplastic resin film such as a polyethylene film. The packaging laminate 1 having the structure shown in FIG. 2 using the adhesive agent layer 6 is more flexibility in laminate itself as compared with the structure shown in FIG. 1. In cases where the packaging object to be packaged by the packaging bag 10 made of the laminate 1 is an electronic material product, as the adhesive agent or the adhesive agent layer 6, a non-silica type adhesive agent or layer which does not include silica can be preferably used. At the time of laminating the layers 2, 4 and 5, the surface of each layer can be subjected to a treatment for improving the adhesiveness such as an ozone treatment.

Concrete layer structure of the packaging laminate 1 of the invention will be exemplified as follows, but the layer structure is not limited to one of these examples. “AC” in the layer structure denotes “anchor coated.”

[Structure with an Aluminum Foil]

*Nylon (surface layer)/AC/PE extruded layer (adhesive agent layer)/Aluminum foil (intermediate layer)/AC/PE extruded layer (adhesive agent layer)/Sealant layer

*Nylon (surface layer)/Aluminum foil (intermediate layer)/AC/PE extruded layer (adhesive agent layer)/Sealant layer

*PET (surface layer)/Aluminum foil (intermediate layer)/Nylon (intermediate layer) AC/PE extruded layer (adhesive agent layer)/Sealant layer

[Structure with No Aluminum Foil]

*Nylon (surface layer)/AC/PE extruded layer (adhesive agent layer)/Sealant layer

*PET (surface layer) AC/PE extrude layer (adhesive agent layer)/Sealant layer

*PET (surface layer)/Nylon (intermediate layer)/AC/PE extrude layer (adhesive agent layer)/Sealant layer

*PET with a transparent barrier film (surface layer)/AC/PE extrude layer (adhesive agent layer)/Sealant layer

*PET with a transparent barrier film (surface layer)/Nylon (intermediate layer)/AC/PE extrude layer (adhesive agent layer)/Sealant layer

Next, an embodiment of a packaging bag 10 of this invention structured using the packaging laminate 1 is shown in FIGS. 3 and 4. This packaging bag 10 is an approximately cubic-shaped bag in an expanded state, and has side films 21 and 22, and gazette films 23 and 24. Each of these films 21, 22, 23 and 24 is a packaging laminate 1 of this invention. The sealant layer 2 of the packaging laminate 1 is located at the inner side.

In the packaging bag 10, as shown in FIG. 3, the side film 21 and the tucked gazette side film 23 are welded at their side edge portions by heat sealing to thereby form a sealed portion 25, while the side film 22 and the tucked gazette side film 23 are welded at their side edge portions by heat sealing to thereby form a sealed portion. Furthermore, the side film 21 and the tucked gazette side film 24 are welded at their side edge portions by heat sealing to thereby form a sealed portion 26, while the side film 22 and the tucked gazette side film 24 are welded at their side edge portions by heat sealing to thereby form a sealed portion.

At the bottom portion of the packaging bag 10, the side films 21 and 22 and the gazette side films 23 and 24 are linearly heat sealed along the transverse direction of the bag to thereby form a bottom sealed portion 27 (see FIG. 3). Furthermore, at the bottom central portion 28 where the gazette side films 23 and 24 do not intervene, the side film 21 and the side film 22 are welded by heat sealing.

Furthermore, as shown in FIG. 3, the portion surrounded by the line obliquely rightwardly upwardly extending from the vicinity of the bottom central portion 28 to the side edge portion, the bottom sealed portion 27 and the sealed portion 25 is heat sealed in an approximately triangular shape. In the same manner, the portion surrounded by the line obliquely leftwardly upwardly extending from the vicinity of the bottom central portion 28 to the side edge portion, the bottom sealed portion 27 and the sealed portion 26 is heat sealed in an approximately triangular shape. Forming such an approximately triangular-shaped heat sealed portion makes it easy to expand the bottom surface of the bag 10 into a square shape. In the approximately triangular shaped heat sealed portion, striped non-sealed portions 29 are formed. The existence of these striped non-sealed portions 29 can restrain the wave phenomenon.

Furthermore, at both end side positions of the bottom sealed portion 27, round spot seals 30 and 30 are formed. By forming these spot seals, the gazette side films 23 and 23 are welded with each other and the gazette side films 24 and 24 are also welded each other. This facilitates the unfolding of the bag 10 into an approximately cubic-shape. “31” denotes a cut-portion for enhancing the opening operation.

In the packaging bag 10, since the bag 10 is constituted by using the packaging laminate 1 of this invention, sufficient seal strength can be obtained. Accordingly, for example, the sealed portion of the bag 10 would not be broken even if the packaging bag expands when a cargo compartment of an aircraft became a midair low pressure state with a packaging object (e.g., an electronic material product) packaged in a sealed manner. Furthermore, the sealant layer 2 is very small in content of ionic impurities, such as, e.g., metallic ions or inorganic ions, which prevents the ionic impurities from being transferred to the packaging object (e.g., an electronic material product). Furthermore, since the density of the film containing the linear ethylene/α-olefin copolymer constituting the sealant layer 2 is set so as to fall within the range of 0.925 to 0.935 g/cm³, the laminate is excellent in slip property and can have appropriate flexibility. Therefore, it is excellent in packaging workability.

The packaging laminate 1 of this invention is very small in content of ionic impurities in the sealant layer 2. Therefore, it can be preferably used as a packaging material for an electronic material product (e.g., silicon wafer, compound semiconductor wafer, hard disk magnetic material, and various electronic material before producing into the aforementioned electronic material products), but not limited to them. For example, it can be used as a medical packaging material, and a packaging material to be used in the field requiring clean property.

The packaging bag 10 of this invention is very small in content of ionic impurities in the sealant layer 2. Therefore, it can be preferably used as a packaging bag for an electronic material product (e.g., silicon wafer, compound semiconductor wafer, hard disk magnetic material, and various electronic material before producing into the aforementioned electronic material products), but not limited to them. For example, it can be used as a medical packaging bag, and a packaging material to be used in the field requiring clean property.

Furthermore, the packaging bag 10 of this invention is not limited to the bag having the shape as shown in FIGS. 3 and 4, and can be any shape so long as the packaging laminate 1 of this invention is used and the sealant layer 2 is used as the innermost layer. For example, it can be formed into a three-side-sealed bag as shown in FIG. 6.

### EXAMPLES

Next, concrete examples of this invention will be explained.

### Example 1

As shown in FIG. 5, while downwardly extruding a 20 μm thick film-like molten resin 6 (temperature: 300° C.) of high pressure method low density polyethylene (melt flow rate: 4 g/10 min) and supplying a 15 μm thick anchor coated biaxially drawn nylon film 3 from the left side in the figure, a 40 μm thick film (sealant layer) 2 made of a linear ethylene/α-olefin copolymer was supplied from the right side of this figure to laminate the film-like molten resin (PE extruded layer) 6 by being pinched with a pair of pressure rolls. Thus, a packaging laminate 1 was obtained.

As the linear ethylene/α-olefin copolymer (sealant layer) 2, a linear ethylene-(hexene-1) copolymer (no additive agent was added) having a density of 0.926 g/cm³ produced with biscyclopentadienyl zirconium complex salt (metallocene catalyst) was used.

The packaging laminate 1 was supplied to a bag-making machine to thereby produce a packaging bag (gazette transparent bag 10) shown in FIG. 3. In FIG. 3, the width (lateral) size was 275 mm, and the length (the vertical length) was 600 mm. The width of each gazette side film 23 and 24 was 260 mm. The sealed width of the side sealed portion 25 and 26 was 10 mm, and the sealed width of the bottom sealed portion 27 was also 100 mm.

### Examples 2 and 3, Comparative Examples 1 to 3

A packaging bag 10 was produced in the same manner as in Example 1 except that as the linear ethylene/α-olefin copolymer (sealant layer) 2, a linear ethylene-(hexene-1) copolymer (no additive agent was added) having a density shown in Table 1 produced with biscyclopentadienyl zirconium complex salt (metallocene catalyst) was used.

### Example 4

A packaging bag 10 was produced in the same manner as in Example 1 except that as the linear ethylene/α-olefin copolymer (sealant layer) 2, a linear ethylene-(butene-1) copolymer (no additive agent was added) having a density of 0.929 g/cm³ produced with biscyclopentadienyl zirconium complex salt (metallocene catalyst) was used.

### Examples 5 and 6, Comparative Examples 6 and 7

A packaging bag 10 was produced in the same manner as in Example 1 except that as the linear ethylene/α-olefin copolymer (sealant layer) 2, a linear ethylene-(hexene-1) copolymer (no additive agent was added) having a density shown in Table 2 produced with a Ziegler catalyst as a polymerization catalyst was used.

As the Zeigler catalyst, a solid catalyst in which titanium tetrachloride was mixed in a magnesium compound and a catalyst made of triisobutyl aluminum were used. The linear ethylene-(hexene-1) copolymer was a polymer in which a Ziegler catalyst and contained ionic impurities such as a Ziegler catalyst residual were reduced using chelation reaction of a Ziegler catalyst and acetylacetone (chelate agent) after the polymerization.

### Examples 7 and 8, Comparative Examples 8 and 9

A packaging bag 10 was produced in the same manner as in Example 1 except that as the linear ethylene/α-olefin copolymer (sealant layer) 2, a linear ethylene-(hexene-1) copolymer (no additive agent was added) having a density shown in Table 2 produced with a Ziegler catalyst as a polymerization catalyst was used.

As the Zeigler catalyst, a solid catalyst in which titanium tetrachloride was mixed in a magnesium compound and a catalyst made of triisobutyl aluminum were used. The linear ethylene-(hexene-1) copolymer was a polymer in which contained ionic impurities such as a Ziegler catalyst residual were reduced by performing an operation for cutting a molten copolymer in clean warm water (e.g. 60° C. warm water) at the time of palletizing the linear ethylene/α-olefin copolymer during the granulation process thereof.

### Comparative Example 4

A packaging bag 10 was produced in the same manner as in Example 1 except that as the sealant layer 2, a low density polyethylene film having a density of 0.920 g/cm³ and a melt flow rate of 1 g/10 min was used as the sealant layer, wherein the low density polyethylene film was produced by a high pressure radical polymerization method using perioxide series radical initiator having a half-life of 170° C.

### Comparative Example 5

A packaging bag 10 was produced in the same manner as in Example 1 except that as the linear ethylene/α-olefin copolymer (sealant layer) 2, a linear ethylene-(butene-1) copolymer (containing erucicamide as lubricant) (no ionic impurity removing operation was performed) having a density of 0.922 g/cm³ produced with a Ziegler catalyst as a polymerization catalyst was used. As the Zeigler catalyst, a solid catalyst in which titanium tetrachloride was mixed in a magnesium compound and a catalyst made of triisobutyl aluminum were used.

The bags obtained above were evaluated by the following evaluation methods. The results are shown in Tables 1-4.

TABLE 1

| | | α-olefin | | Seal | Dynamic | |
|---|---|---|---|---|---|---|
| | | component | Density | strength | friction | Packaging |
| | Catalyst | of copolymer | (g/cm³) | (N/15 mm) | coefficient | workability |
| Comp. | Metallocene | Hexene-1 | 0.918 | 59 | 0.82 | X |
| Ex. 1 | Catalyst | | | | | |
| | (Zr series) | | | | | |
| Comp. | Metallocene | Hexene-1 | 0.923 | 60 | 0.75 | X |
| Ex. 2 | Catalyst | | | | | |
| | (Zr series) | | | | | |
| Ex. 1 | Metallocene | Hexene-1 | 0.926 | 62 | 0.64 | ◯ |
| | Catalyst | | | | | |
| | (Zr series) | | | | | |
| Ex. 2 | Metallocene | Hexene-1 | 0.930 | 60 | 0.60 | ⊚ |
| | Catalyst | | | | | |
| | (Zr series) | | | | | |
| Ex. 3 | Metallocene | Hexene-1 | 0.934 | 59 | 0.54 | ◯ |
| | Catalyst | | | | | |
| | (Zr series) | | | | | |
| Comp. | Metallocene | Hexene-1 | 0.940 | 50 | 0.45 | X |
| Ex. 3 | Catalyst | | | | | |
| | (Zr series) | | | | | |
| Comp. | High pressure | Hexene-1 | 0.920 | 38 | 0.53 | ⊚ |
| Ex. 4 | radical | | | | | |
| | polymerization | | | | | |
| | method | | | | | |
| Comp. | Ziegler | Hexene-1 | 0.922 | 60 | 0.45 | ⊚ |
| Ex. 5 | catalyst | | | | | |
| Ex. 4 | Metallocene | Butene-1 | 0.929 | 61 | 0.59 | ⊚ |
| | Catalyst | | | | | |
| | (Zr series) | | | | | |

TABLE 2

| | | α-olefin | | Seal | Dynamic | |
|---|---|---|---|---|---|---|
| | | component | Density | strength | friction | Packaging |
| | Catalyst | of copolymer | (g/cm³) | (N/15 mm) | coefficient | workability |
| Comp. | Ziegler | Hexene-1 | 0.923 | 58 | 0.75 | X |
| Ex. 6 | Catalyst *1 | | | | | |
| Ex. 5 | Ziegler | Hexene-1 | 0.926 | 59 | 0.63 | ◯ |
| | Catalyst *1 | | | | | |
| Ex. 6 | Ziegler | Hexene-1 | 0.930 | 60 | 0.60 | ⊚ |
| | Catalyst *1 | | | | | |
| Comp. | Ziegler | Hexene-1 | 0.940 | 55 | 0.46 | X |
| Ex. 7 | Catalyst *1 | | | | | |
| Comp. | Ziegler | Hexene-1 | 0.923 | 60 | 0.74 | X |
| Ex. 8 | Catalyst *2 | | | | | |
| Ex. 7 | Ziegler | Hexene-1 | 0.926 | 60 | 0.62 | ◯ |
| | Catalyst *2 | | | | | |
| Ex. 8 | Ziegler | Hexene-1 | 0.932 | 61 | 0.58 | ⊚ |
| | Catalyst *2 | | | | | |
| Comp. | Ziegler | Hexene-1 | 0.940 | 57 | 0.45 | X |
| Ex. 9 | Catalyst *2 | | | | | |

*1 Contained ionic impurities such as a Ziegler catalyst were removed using chelation reaction after the polymerization
*2 Contained ionic impurities such as a Ziegler catalyst were removed by cutting a molten copolymer in clean warm water after the polymerization

TABLE 3

| | Ionic impurity extracted amount (picogram/mL) | | | | | | | | | |
|---|---|---|---|---|---|---|---|---|---|---|
| | Chlorine | Nitrate | Sulfate | Ammonia | Metallic ion | | | | | |
| | ion | ion | ion | ion | Na | Mg | Al | Ca | Fe | Zn |
| Comp. | 60 | 50 | 0 | 143 | 7 | 0 | 7 | 0 | 0 | 0 |
| Ex. 1 | | | | | | | | | | |
| Comp. | 86 | 20 | 23 | 26 | 13 | 8 | 7 | 0 | 2 | 0 |
| Ex. 2 | | | | | | | | | | |
| Ex. 1 | 12 | 38 | 5 | 50 | 6 | 0 | 7 | 0 | 0 | 0 |
| Ex. 2 | 0 | 34 | 11 | 62 | 8 | 0 | 12 | 0 | 0 | 0 |
| Ex. 3 | 10 | 25 | 3 | 27 | 5 | 0 | 9 | 0 | 0 | 0 |
| Comp. | 30 | 40 | 6 | 32 | 7 | 0 | 8 | 0 | 2 | 0 |
| Ex. 3 | | | | | | | | | | |
| Comp. | 0 | 180 | 0 | 45 | 7 | 4 | 5 | 10 | 10 | 4.5 |
| Ex. 4 | | | | | | | | | | |
| Comp. | 1800 | 510 | 560 | 125 | 127 | 88 | 50 | 430 | 3 | 350 |
| Ex. 5 | | | | | | | | | | |
| Ex. 4 | 25 | 52 | 5 | 28 | 8 | 0 | 8 | 0 | 1 | 0 |

TABLE 4

| | Ionic impurity extracted amount (picogram/mL) | | | | | | | | | |
|---|---|---|---|---|---|---|---|---|---|---|
| | Chlorine | Nitrate | sulfate | Ammonia | Metallic ion | | | | | |
| | ion | ion | ion | ion | Na | Mg | Al | Ca | Fe | Zn |
| Comp. | 62 | 59 | 14 | 32 | 12 | 3 | 14 | 2 | 5 | 16 |
| Ex. 6 | | | | | | | | | | |
| Ex. 5 | 45 | 58 | 12 | 56 | 16 | 4 | 17 | 4 | 9 | 21 |
| Ex. 6 | 56 | 47 | 12 | 42 | 9 | 2 | 10 | 6 | 8 | 9 |
| Comp. | 38 | 49 | 8 | 29 | 18 | 4 | 18 | 2 | 5 | 28 |
| Ex. 7 | | | | | | | | | | |
| Comp. | 42 | 67 | 38 | 47 | 23 | 16 | 24 | 58 | 7 | 56 |
| Ex. 8 | | | | | | | | | | |
| Ex. 7 | 36 | 47 | 21 | 59 | 34 | 27 | 18 | 43 | 12 | 39 |
| Ex. 8 | 58 | 38 | 44 | 38 | 45 | 12 | 15 | 49 | 8 | 47 |
| Comp. | 59 | 39 | 36 | 54 | 28 | 19 | 21 | 23 | 11 | 28 |
| Ex. 9 | | | | | | | | | | |

<Seal Strength Measuring Method>

The seal strength of the side sealed portion 25, the side sealed portion 26 and the bottom sealed portion 27 of the bag 10 were measured at each 4 portions, i.e., a total of 12 portions, and the average value was defined as the seal strength. The sealed portion was pealed at a crosshead speed of 100 mm/min using a tensile testing machine, and the peal strength was defined as the seal strength.

<Packaging Workability Evaluation Method>

The packaging workability at the time of packaging a polypropylene storage case in which 25 sheets of 200 mm diameter silicon wafers were stored with a packaging bag was evaluated based on the following evaluation standard.

(Evaluation Standard)

⊚ . . . The packaging bag has appropriate rigidity and softness. Even if the sealant layer of the packaging bag and the storage case come into contact with each other, the slip property is good. Furthermore, the rigidity of the packaging bag is appropriate and therefore the packaging operation can be performed very smoothly.

◯ . . . Even if the sealant layer of the packaging bag and the storage case come into contact with each other, good slip property can be obtained. Therefore, the packaging operation can be performed smoothly.

X . . . Since the slip performance when the sealant layer of the packaging bag and the storage case come into contact with each other is poor, and/or since the rigidity of the packaging bag is too strong, the packaging operation cannot be performed smoothly.

<Evaluation Method of Ionic Impurity Content>

Pure water 1000 mL was poured in the packaging bag 10 (so that the water comes into contact with the area 2,500 cm² of the sealant layer of the bag), and the contact extraction was performed by shaking it for 2 minutes. Thereafter, the analysis of the extracted amount of ionic impurities by sampling a certain amount was performed. As to chlorine ion, nitrate ion, sulfate ion, and ammonia ion, quantitative measurement was performed with an ion chromatography. As to metallic ion, the quantity was determined by ICP/MS analysis. In performing the ion chromatography analysis, DX300/DX500 manufactured by Dionex Kabushiki Kaisha was used. In performing the ICP/MS analysis, SPG-9000 manufactured by Seiko Instrument Kabushiki Kaisha was used.

As will be apparent from Tables, the packaging laminates and bags of Examples 1 to 8 of this invention had sufficient seal strength. Furthermore, the content of ion impurities, such as, e.g., metallic ions, or organic ions, was extremely reduced, and the packaging workability was excellent.

To the contrary, the packaging laminates and bags of Comparative Examples 1-3, 6, 7, 8 and 9 were poor in packaging workability. Furthermore, in the packaging laminate and bag of Comparative Example 4, sufficient seal strength could not be obtained. Furthermore, in the packaging laminate and bag of Comparative Example 5, the content of ionic impurities, such as, e.g., metallic ions, organic ions, was large.

This application claims to Japanese Patent Application No. 2004-326083 filed on Nov. 10, 2004, the entire disclosure of which is incorporated herein by reference in its entirety.

The terms and expressions which have been employed herein are used as terms of description and not of limitation. This invention allows any design modification within the scope of the claimed range so long as the modification does not deviate the spirits of the invention.

### INDUSTRIAL APPLICABILITY

The packaging laminate and packaging bag of this invention can be used to package an electronic material product such as a wafer case in which a silicon wafer, a compound semiconductor wafer, or a hard disk is enclosed. Furthermore, it also can be used as a medical packaging bag and a packaging bag to be used in the field requiring clean property.

1. A packaging laminate, comprising:
at least a sealant layer,
wherein the sealant layer comprises a film having a density of 0.925 to 0.935 g/cm³ and containing a linear ethylene/α-olefin copolymer, the film containing no additive, and
wherein the linear ethylene/α-olefin copolymer is a copolymer produced with a metallocene catalyst as a polymerization catalyst.

2. A packaging laminate, comprising:
at least a sealant layer,
wherein the sealant layer comprises a film having a density of 0.925 to 0.935 g/cm³ and containing a linear ethylene/α-olefin copolymer, the film containing no additive,
wherein as the linear ethylene/α-olefin copolymer, a copolymer obtained by subjecting a linear ethylene/α-olefin copolymer produced with a Ziegler catalyst as a polymerization catalyst to an ionic impurity removing operation and in which contained ionic impurities have been diminished or removed is used.

3. The packaging laminate as recited in claim 2, wherein the ionic impurity removing operation is an operation for reducing or removing contained ionic impurities such as a Zeigler catalyst utilizing a chelation reaction of a Ziegler catalyst and a chelate agent.

4. The packaging laminate as recited in claim 2, wherein the ionic impurity removing operation is an operation for reducing or removing contained ionic impurities such as a Zeigler catalyst by performing an operation for cutting a molten copolymer in clean warm water at the time of palletizing the linear ethylene/α-olefin copolymer during a granulation process.

5. The packaging laminate as recited in any one of claims 1 to 4, wherein the film constituting the sealant layer is 0.928 to 0.933 g/cm³ in density.

6. A packaging bag using the packaging laminate as recited in any one of claims 1 to 5, wherein the sealant layer of the packaging laminate constitutes an innermost layer of the packaging bag.

7. A packaging bag for electronic material products using the packaging laminate as recited in any one of claims 1 to 5, wherein the sealant layer of the packaging laminate constitutes an innermost layer of the packaging bag.
